(19) United States
(12) Patent Application Publication
(10) Pub. No.: US 2016/0149480 A1
(43) Pub. Date: May 26, 2016

(54) POWER SUPPLY WITH LOW VOLTAGE PROTECTION AND METHOD OF OPERATING THE SAME

(71) Applicant: Power Forest Technology Corporation, Zhubei City (TW)

(72) Inventors: Ren-Huei TZENG, Hsinchu County (TW); Kuan-Sheng WANG, Hsinchu County (TW); Hsien-Yuan CHIANG, Hsinchu County (TW)

(21) Appl. No.: 14/887,616

(22) Filed: Oct. 20, 2015

(30) Foreign Application Priority Data
Nov. 21, 2014 (TW) 103140408

(51) Int. Cl. H02M 1/32; H02M 3/335

(52) U.S. Cl. CPC H02M 1/32; H02M 3/33523

(57) ABSTRACT

A power supply with low voltage protection provides an output voltage. The power supply includes a driving switch and a control unit. The control unit generates a control signal with a duty cycle. The driving switch receives the control signal to drive the output voltage of the power supply. The control unit enables an under-voltage protection mode when the control unit detects that the output voltage is less than a threshold output voltage value and the duty cycle is less than a maximum duty cycle value. The control unit disables the under-voltage protection mode when the control unit detects that the output voltage is less than the threshold output voltage value and the duty cycle reaches to the maximum duty cycle value.

### BACKGROUND

1. Technical Field

The present disclosure generally relates to a power supply, and more particularly to a power supply with a low voltage protection and a method of operating the same.

2. Description of Related Art

For the supply power, the phenomenon of temporary reduction of the output voltage thereof is normal because the power-supplying transformation between different power plants, such as the power-supplying transformation is from an A plant to a B plant, or vice versa. Accordingly, an auto-recovery protection function instead of a latch protection function should be executed once the temporary reduction of the output voltage occurs, thereby avoiding locking the power supply.

Accordingly, it is desirable to provide a power supply with a low voltage protection and a method of operating the same to judge whether an under-voltage protection mode is executed or not by comparing the output voltage to a threshold output voltage value and comparing the duty cycle to a maximum duty cycle value.

### SUMMARY

An object of the present disclosure is to provide a power supply with a low voltage protection to solve the above-mentioned problems. Accordingly, the power supply with the low voltage protection provides an output voltage, and the power supply includes a driving switch and a control unit. The control unit generates a control signal with a duty cycle. The driving switch receives the control signal to drive the output voltage of the power supply. The control unit enables an under-voltage protection mode to stop outputting the control signal and turn off the driving switch when the control unit detects that the output voltage is less than a threshold output voltage value preset by the control unit and the control unit detects that the duty cycle is less than a maximum duty cycle value. The control unit disables the under-voltage protection mode when the output voltage is less than the threshold output voltage value and the duty cycle reaches the maximum duty cycle value.

Another object of the present disclosure is to provide a method of operating a power supply with a low voltage protection to solve the above-mentioned problems. Accordingly, the power supply provides an output voltage, and the method includes: (a) providing a driving switch; (b) providing a control unit to generate a control signal with a duty cycle; wherein the driving switch is configured to receive the control signal to drive the output voltage of the power supply; (c) enabling an under-voltage protection mode by the control unit to stop outputting the control signal and turn off the driving switch when the control unit detects that the output voltage is less than a threshold output voltage value and the duty cycle is less than a maximum duty cycle value; and (d) disabling the under-voltage protection mode by the control unit when the control unit detects that the output voltage is less than the threshold output voltage value and the duty cycle reaches to the maximum duty cycle value.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic circuit block diagram of a power supply with a low voltage protection according to the present disclosure;

FIG. 2 is a schematic circuit block diagram of a control unit according to the present disclosure;

FIG. 3 is a schematic view of the low voltage protection of the power supply according to the present disclosure;

FIG. 4 is a schematic view of the abnormal voltage protection of the power supply according to the present disclosure;

FIG. 5 is a circuit diagram of the power supply with the low voltage protection according to the present disclosure; and

FIG. 6 is a flowchart of a method of operating a power supply with a low voltage protection according to the present disclosure.

### DETAILED DESCRIPTION

Reference will now be made to the drawing figures to describe the present disclosure in detail.

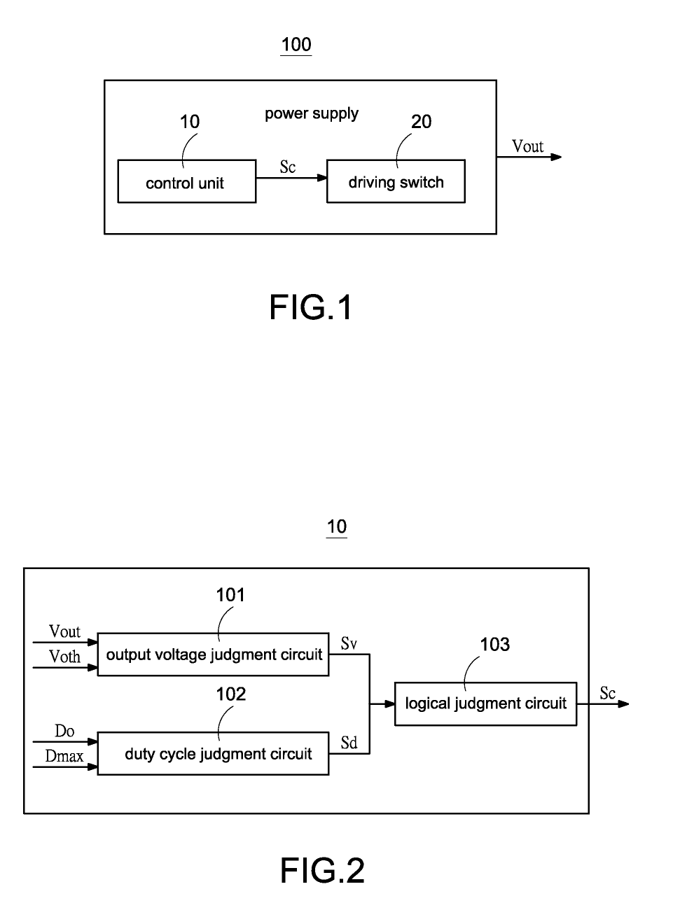

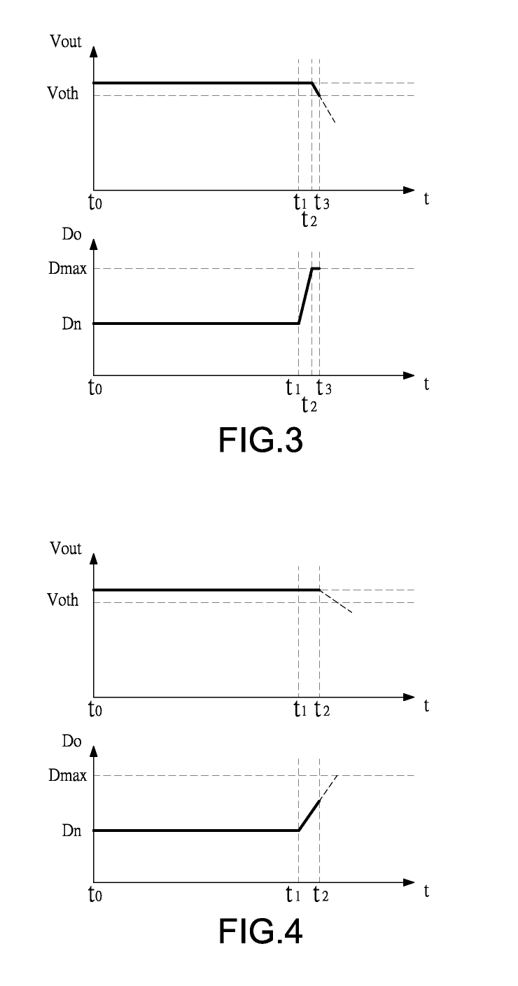

Reference is made to FIG. 1 which is a schematic circuit block diagram of a power supply with a low voltage protection according to the present disclosure. The power supply 100 with the low voltage protection provides an output voltage Vout, and the power supply 100 includes a driving switch 20 and a control unit 10. The control unit 10 generates a control signal Sc with a duty cycle Do. The driving switch 20 receives the control signal Sc to drive the output voltage Vout of the power supply 100. The control unit 10 enables an under-voltage protection mode to stop outputting the control signal Sc and turns off the driving switch 20 when the control unit 10 detects that the output voltage Vout is less than a threshold output voltage value Voth (as shown in FIG. 3 or FIG. 4) preset by the control unit 10 and the control unit 10 detects that the duty cycle Do is less than a maximum duty cycle value Dmax. In particular, the maximum duty cycle value Dmax can be preset to between 70% and 80%. However, this example is for demonstration and not for limitation of the present disclosure. On the contrary, the control unit 10 disables the under-voltage protection mode when the output voltage Vout is less than the threshold output voltage value Voth and the duty cycle Do reaches the maximum duty cycle value Dmax.

Especially, the above-mentioned under-voltage protection mode can be a latch mode, which is executed to stop outputting the control signal Sc. In addition, the under-voltage protection mode can be an auto-recovery mode, which is executed to re-output the control signal Sc after stopping outputting the control signal Sc for a predetermined time. The power supply 100 further includes a feedback circuit 108, which is used to feed back the output voltage Vout to the control unit 10. The detailed operation of the power supply 100 with the low voltage protection will be described hereinafter as follows.

Reference is made to FIG. 2 which is a schematic circuit block diagram of a control unit according to the present disclosure. The control unit 10 includes an output voltage judgment circuit 101, a duty cycle judgment circuit 102, and a logical judgment circuit 103. The output voltage judgment circuit 101 receives the output voltage Vout and the threshold output voltage value Voth to compare the output voltage Vout to the threshold output voltage value Voth, thereby outputting a voltage judgment signal Sv. The duty cycle judgment circuit 102 receives the duty cycle Do and the maximum duty cycle value Dmax to compare the duty cycle Do to the maximum duty cycle value Dmax, thereby outputting a duty cycle judgment signal Sd. The logical judgment circuit 103 receives the voltage judgment signal Sv and the duty cycle judgment signal Sd to output the control signal Sc so as to control the control unit 10 enabling or disabling the under-voltage protection mode. Especially, either the output voltage judgment circuit 101 or the duty cycle judgment circuit 102 can be implemented by an operational amplifier (OPA) or an equivalent circuit.

The voltage judgment signal Sv outputted from the output voltage judgment circuit 101 is a high-level signal, namely Sv=1 when the output voltage Vout is less than the threshold output voltage value Voth. On the contrary, the voltage judgment signal Sv is a low-level signal, namely Sv=0 when the output voltage Vout is greater than or equal to the threshold output voltage value Voth.

In addition, the duty cycle judgment signal Sd outputted from the duty cycle judgment circuit 102 is a high-level signal, namely Sd=1 when the duty cycle Do is less than the maximum duty cycle value Dmax. On the contrary, the duty cycle judgment signal Sd is a low-level signal, namely Sd=0 when the duty cycle Do reaches the maximum duty cycle value Dmax.

Especially, the logical judgment circuit 103 can be a logic AND gate. The control unit 10 enables the under-voltage protection mode when the logical judgment circuit 103 receives the high-level voltage judgment signal Sv and the high-level duty cycle judgment signal Sd. In other words, the control unit 10 enables the under-voltage protection mode when the output voltage Vout is less than the threshold output voltage value Voth and also the duty cycle Do is less than the maximum duty cycle value Dmax.

In addition, the control unit 10 disables the under-voltage protection mode when the logical judgment circuit 103 receives the high-level voltage judgment signal Sv and the low-level duty cycle judgment signal Sd. In other words, the control unit 10 disables the under-voltage protection mode when the output voltage Vout is less than the threshold output voltage value Voth and also the duty cycle Do reaches the maximum duty cycle value Dmax.

Reference is made to FIG. 3 which is a schematic view of the low voltage protection of the power supply according to the present disclosure. The upper part of FIG. 3 illustrates the output voltage Vout and the lower part illustrates the duty cycle Do of the control signal Sc. After a time point t0, it is assumed that the power supply 100 is operated under the normal AC input voltage Vac. Hence, the duty cycle Do of the control signal Sc generated from the control unit 10 is equal to a normal duty cycle Dn, and the duty cycle Do with the normal duty cycle Dn is provided to drive the driving switch 20 so that the output voltage Vout is kept approximately constant during the loading operation.

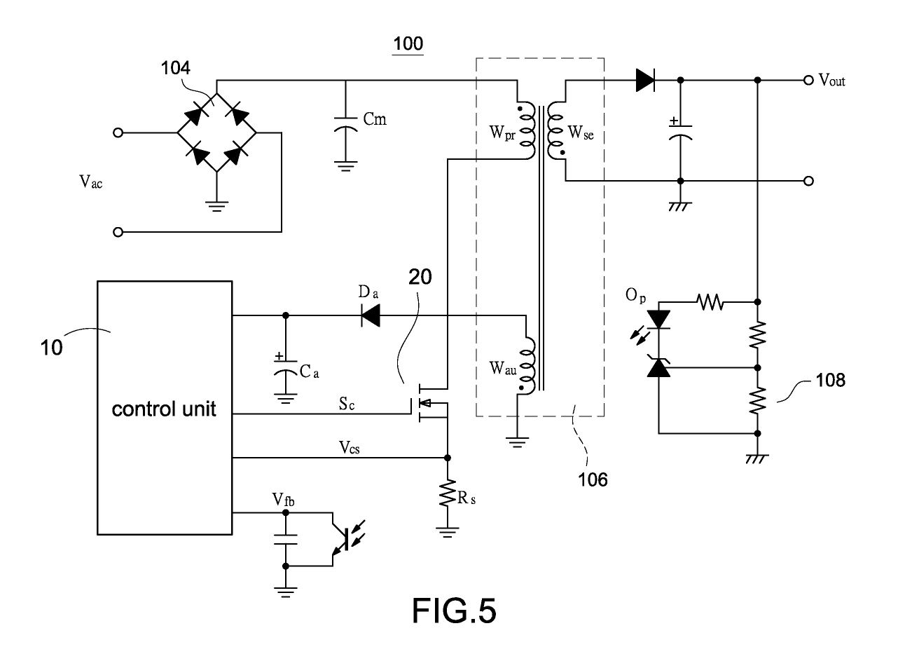

It is assumed that the temporary interruption of the AC input voltage Vac occurs when the power-supplying transformation between different power plants at a time point t1. As a result, the feedback circuit 108 detects that the output voltage Vout of the power supply is reduced. At this time, the feedback circuit 108 feeds back the output voltage Vout via the optical coupler Op (as shown in FIG. 5) and generates the voltage feedback signal Vfb to notify the control unit 10. Accordingly, the control unit 10 controls the duty cycle of the control signal Sc gradually increasing from the normal duty cycle Dn to keep the output voltage Vout approximately constant.

At a time point t2, the duty cycle Do of the control signal Sc is increased to reach a maximum duty cycle value Dmax. If the temporary interruption of the AC input voltage Vac still occurs, the output voltage Vout will be gradually reduced because the duty cycle of the control signal Sc is in the maximum value.

At a time point t3, the output voltage judgment circuit 101 outputs the high-level voltage judgment signal Sv when the output voltage judgment circuit 101 judges that the output voltage Vout is less than the threshold output voltage value Voth. Meanwhile, the duty cycle judgment circuit 102 outputs the low-level duty cycle judgment signal Sd when the duty cycle judgment circuit 102 judges that the duty cycle Do reaches the maximum duty cycle value Dmax. In other words, the control unit 10 disables the under-voltage protection mode when the output voltage judgment circuit 101 judges that the output voltage Vout is less than the threshold output voltage value Voth and also the duty cycle judgment circuit 102 judges that the duty cycle Do reaches the maximum duty cycle value Dmax.

Reference is made to FIG. 4 which is a schematic view of the abnormal voltage protection of the power supply according to the present disclosure. As mentioned above, the normal duty cycle Dn of the control signal Sc is increased to keep the output voltage Vout approximately constant when the power supply 100 detects that the output voltage Vout starts to reduce. Until the normal duty cycle Dn is increased to reach the maximum duty cycle value Dmax and the output voltage Vout starts to reduce and also is less than a threshold output voltage value, the under-voltage protection mode is disabled. As shown in FIG. 4, the output voltage Vout starts to reduce at the time point t2 but the duty cycle Do does not reach the maximum duty cycle value Dmax. It is obvious that the power supply is abnormally operated because of abnormal operation of the feedback circuit 108. In addition, the duty cycle Do may be also reduced at the time point t0 and the output voltage Vout reduces. When the above-mentioned abnormal operations of the power supply occur, the abnormal-voltage protection mechanism would be started up.

Reference is made to FIG. 5 which is a circuit diagram of the power supply with the low voltage protection according to the present disclosure. The power supply 100 mainly includes a full-wave rectifier 104, a transformer 106, a control unit 10, a driving switch 20, a filtering capacitor Cm, and an auxiliary capacitor Ca. The power supply 100 provides a flyback converter, but not limited. The flyback converter has the transformer 106 with a primary-side winding Wpr, a secondary-side winding Wse, and an auxiliary winding Wau. The full-wave rectifier 104 receives an AC input voltage Vac and rectifies the AC input voltage Vac to generate a DC input voltage.

The filtering capacitor Cm is electrically connected to one terminal of the primary-side winding Wpr at a high voltage side of the power supply 100. The DC input voltage is filtered by the filtering capacitor Cm to provide the output power from the power supply 100. The auxiliary capacitor Ca is electrically connected to the auxiliary winding Wau via an auxiliary diode Da. A first terminal of the driving switch 20 is electrically connected to the other terminal of the primary-side winding Wpr, and a second terminal of the driving switch 20 is electrically connected to a sensing resistor Rs. The sensing resistor Rs is connected in series to the driving switch 20 to sense a current flowing through the driving switch 20 and generate a current-sensing signal Vcs to the control unit 10.

The control unit 10 is electrically connected to the filtering capacitor Cm, a driving terminal of the driving switch 20, and the sensing resistor Rs. The control unit 10 generates a control signal Sc to turn on or turn off the driving switch 20, thereby controlling generated power transmitted from the primary side to the secondary side of the transformer 106 and generating an output voltage Vout at the secondary side of the transformer 106. In particular, the control unit 10 can be a pulse-width modulation IC (PWM IC).

In addition, the power supply 100 further includes a feedback circuit 108, which can be implemented by an optical-coupled sensor. More specifically, the feedback circuit 108 provides a resistor network to detect the output voltage Vout and provides an optical coupler Op to feed back the output voltage Vout by generating a voltage feedback signal Vfb to the control unit 10.

In conclusion, the technical feature of the present disclosure is that: the phenomenon of temporary reduction of the output voltage Vout of the power supply is normal because the power-supplying transformation between different power plants; and the power supply can disable the under-voltage protection mode to provide the proper protection mechanism once the phenomenon occurs.

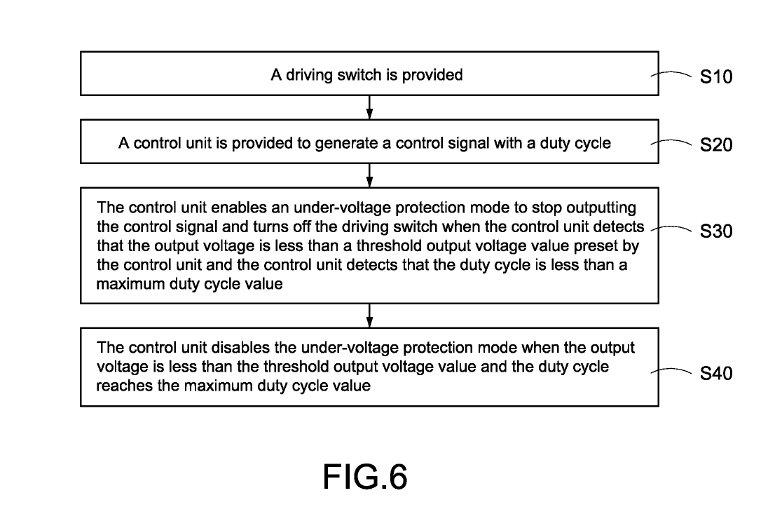

Reference is made to FIG. 6 which is a flowchart of a method of operating a power supply with a low voltage protection according to the present disclosure. The power supply provides an output voltage. The method includes the following steps. First, a driving switch is provided (S10). In particular, the driving switch can be a metal-oxide-semiconductor field-effect transistor (MOSFET) switch, but not limited.

Afterward, a control unit is provided to generate a control signal with a duty cycle (S20). In particular, the driving switch receives the control signal to drive the output voltage of the power supply.

The control unit enables an under-voltage protection mode to stop outputting the control signal and turns off the driving switch when the control unit detects that the output voltage is less than a threshold output voltage value preset by the control unit and the control unit detects that the duty cycle is less than a maximum duty cycle value (S30). In particular, the maximum duty cycle value can be preset to between 70% and 80%. However, this example is for demonstration and not for limitation of the present disclosure. Especially, the above-mentioned under-voltage protection mode can be a latch mode, which is executed to stop outputting the control signal. In addition, the under-voltage protection mode can be an auto-recovery mode, which is executed to re-output the control signal after stopping outputting the control signal for a predetermined time. The power supply further includes a feedback circuit, which is used to feed back the output voltage to the control unit.

On the contrary, the control unit disables the under-voltage protection mode when the output voltage is less than the threshold output voltage value and the duty cycle reaches the maximum duty cycle value (S40). The detailed operation of the power supply with the low voltage protection will be described hereinafter as follows.

The control unit includes an output voltage judgment circuit, a duty cycle judgment circuit, and a logical judgment circuit. The output voltage judgment circuit receives the output voltage and the threshold output voltage value to compare the output voltage to the threshold output voltage value, thereby outputting a voltage judgment signal. The duty cycle judgment circuit receives the duty cycle and the maximum duty cycle value to compare the duty cycle to the maximum duty cycle value, thereby outputting a duty cycle judgment signal. The logical judgment circuit receives the voltage judgment signal and the duty cycle judgment signal to output the control signal so as to control the control unit enabling or disabling the under-voltage protection mode. Especially, either the output voltage judgment circuit or the duty cycle judgment circuit can be implemented by an operational amplifier (OPA) or an equivalent circuit.

The voltage judgment signal outputted from the output voltage judgment circuit is a high-level signal when the output voltage is less than the threshold output voltage value. On the contrary, the voltage judgment signal is a low-level signal when the output voltage is greater than or equal to the threshold output voltage value.

In addition, the duty cycle judgment signal outputted from the duty cycle judgment circuit is a high-level signal when the duty cycle is less than the maximum duty cycle value. On the contrary, the duty cycle judgment signal is a low-level signal when the duty cycle reaches the maximum duty cycle value.

Especially, the logical judgment circuit can be a logic AND gate. The control unit enables the under-voltage protection mode when the logical judgment circuit receives the high-level voltage judgment signal and the high-level duty cycle judgment signal. In other words, the control unit enables the under-voltage protection mode when the output voltage is less than the threshold output voltage value and also the duty cycle is less than the maximum duty cycle value.

In addition, the control unit disables the under-voltage protection mode when the logical judgment circuit receives the high-level voltage judgment signal and the low-level duty cycle judgment signal. In other words, the control unit disables the under-voltage protection mode when the output voltage is less than the threshold output voltage value and also the duty cycle reaches the maximum duty cycle value.

In conclusion, the present disclosure has following advantages:

1. The phenomenon of temporary reduction of the output voltage Vout of the power supply is normal because the power-supplying transformation between different power plants; and the power supply can disable the under-voltage protection mode to provide the proper protection mechanism once the phenomenon occurs, thereby avoiding locking the power supply; and

2. It is easy to judge whether the under-voltage protection mode is enabled or disabled by detecting the output voltage Vout and comparing to a threshold output voltage value Voth and detecting the duty cycle Do and comparing to a maximum duty cycle value Dmax by a simple circuit.

What is claimed is:

1. A power supply with a low voltage protection providing an output voltage, comprising:
a driving switch; and
a control unit, configured to generate a control signal with a duty cycle; the driving switch configured to receive the control signal to drive the output voltage of the power supply;
wherein the control unit is configured to enable an under-voltage protection mode to stop outputting the control signal and turn off the driving switch when the control unit is configured to detect that the output voltage is less than a threshold output voltage value preset by the control unit and the control unit is configured to detect that the duty cycle is less than a maximum duty cycle value; the control unit is configured to disable the under-voltage protection mode when the output voltage is less than the threshold output voltage value and the duty cycle reaches the maximum duty cycle value.

2. The power supply with the low voltage protection in claim 1, wherein the under-voltage protection mode is a latch mode that is executed to stop outputting the control signal.

3. The power supply with the low voltage protection in claim 1, wherein the under-voltage protection mode is an auto-recovery mode that is executed to re-output the control signal after stopping outputting the control signal for a predetermined time.

4. The power supply with the low voltage protection in claim 1, wherein the control unit comprises:
an output voltage judgment circuit configured to receive the output voltage and the threshold output voltage value to compare the output voltage to the threshold output voltage value, thereby generating a voltage judgment signal;
a duty cycle judgment circuit configured to receive the duty cycle and the maximum duty cycle value to compare the duty cycle to the maximum duty cycle value, thereby generating a duty cycle judgment signal; and
a logical judgment circuit configured to receive the voltage judgment signal and the duty cycle judgment signal to output the control signal, thereby enabling or disabling the under-voltage protection mode.

5. The power supply with the low voltage protection in claim 4, wherein the voltage judgment signal is a high-level signal when the output voltage is less than the threshold output voltage value; the voltage judgment signal is a low-level signal when the output voltage is greater than or equal to the threshold output voltage value.

6. The power supply with the low voltage protection in claim 5, wherein the duty cycle judgment signal is a high-level signal when the duty cycle is less than the maximum duty cycle value; the duty cycle judgment signal is a low-level signal when the duty cycle reaches the maximum duty cycle value.

7. The power supply with the low voltage protection in claim 6, wherein the logical judgment circuit is a logic AND gate; the control unit is configured to enable the under-voltage protection mode when the logical judgment circuit receives the high-level voltage judgment signal and the high-level duty cycle judgment signal; the control unit is configured to disable the under-voltage protection mode when the logical judgment circuit receives the high-level voltage judgment signal and the low-level duty cycle judgment signal.

8. The power supply with the low voltage protection in claim 4, further comprising:
a feedback circuit configured to transmit the output voltage to the control unit.

9. A method of operating a power supply with a low voltage protection, the power supply configured to provide an output voltage; the method comprising:
(a) providing a driving switch;
(b) providing a control unit to generate a control signal with a duty cycle; wherein the driving switch is configured to receive the control signal to drive the output voltage of the power supply;
(c) enabling an under-voltage protection mode by the control unit to stop outputting the control signal and turn off the driving switch when the control unit detects that the output voltage is less than a threshold output voltage value and the duty cycle is less than a maximum duty cycle value; and
(d) disabling the under-voltage protection mode by the control unit when the control unit detects that the output voltage is less than the threshold output voltage value and the duty cycle reaches to the maximum duty cycle value.

10. The method of operating the power supply in claim 9, wherein the under-voltage protection mode is a latch mode that is executed to stop outputting the control signal.

11. The method of operating the power supply in claim 9, wherein the under-voltage protection mode is an auto-recovery mode that is executed to re-output the control signal after stopping outputting the control signal for a predetermined time.

12. The method of operating the power supply in claim 9, wherein the control unit comprises:
an output voltage judgment circuit configured to receive the output voltage and the threshold output voltage value to compare the output voltage to the threshold output voltage value, thereby generating a voltage judgment signal;
a duty cycle judgment circuit configured to receive the duty cycle and the maximum duty cycle value to compare the duty cycle to the maximum duty cycle value, thereby generating a duty cycle judgment signal; and
a logical judgment circuit configured to receive the voltage judgment signal and the duty cycle judgment signal to output the control signal, thereby enabling or disabling the under-voltage protection mode.

13. The method of operating the power supply in claim 12, wherein the voltage judgment signal is a high-level signal when the output voltage is less than the threshold output voltage value; the voltage judgment signal is a low-level signal when the output voltage is greater than or equal to the threshold output voltage value.

14. The method of operating the power supply in claim 13, wherein the duty cycle judgment signal is a high-level signal when the duty cycle is less than the maximum duty cycle value; the duty cycle judgment signal is a low-level signal when the duty cycle reaches the maximum duty cycle value.

15. The method of operating the power supply in claim 14, wherein the logical judgment circuit is a logic AND gate; the control unit is configured to enable the under-voltage protection mode when the logical judgment circuit receives the high-level voltage judgment signal and the high-level duty cycle judgment signal; the control unit is configured to disable the under-voltage protection mode when the logical judgment circuit receives the high-level voltage judgment signal and the low-level duty cycle judgment signal.

16. The method of operating the power supply in claim 12, further comprising:
providing a feedback circuit to transmit the output voltage to the control unit.
